(19) United States
(12) Patent Application Publication
(10) Pub. No.: US 2005/0106435 A1
(43) Pub. Date: May 19, 2005

(54) Twin-wire arc deposited electrode, solid electrolyte membrane, membrane electrode assembly and fuel cell

(76) Inventors: Bor Z. Jang, Fargo, ND (US); Wen C. Huang, Fargo, ND (US); Leon Wu, Fargo, ND (US)

Correspondence Address: Bor Z. Jang, 2902, 28 AVE, S.W., FARGO, ND, 58103, US

(21) Appl. No.: 10/706,205

(22) Filed: Nov. 13, 2003

(51) Int. Cl. B05D 5/12; H01M 4/88; H01M 8/00; H01M 4/86

(52) U.S. Cl. 429/30; 427/115; 502/101; 429/40

(57) ABSTRACT

A twin-wire arc deposition method for depositing a nano-structured catalyst coating onto a solid electrolyte membrane or an electrode substrate from a precursor catalyst material selected from the group consisting of a metal, metal alloy, metal compound, and ceramic material. The method includes the steps of (a) providing an ionized arc nozzle comprising two consumable electrode and a working gas flow to form an ionized arc between the two electrodes, wherein the consumable electrodes provide the precursor catalyst material vaporizable therefrom by the ionized arc; (b) operating the arc nozzle to heat and at least partially vaporize the precursor catalyst material for providing a stream of nanometer-sized vapor clusters of the precursor catalyst material into a chamber in which the membrane or the electrode substrate has been placed; and (c) introducing a stream of a carrier gas into the chamber to impinge upon the stream of precursor vapor clusters to produce depositable nano clusters which are carried by the carrier gas to deposit onto a first side of the membrane or the electrode substrate for forming the nano-structured catalyst coating. Such a catalyst-coated membrane or electrode can be incorporated as a part of a fuel cell.

This invention results from a research sponsored by the U.S. NSF SBIR Program. The U.S. government has certain rights on this invention.

### FIELD OF THE INVENTION

The present invention relates to a gas diffusion electrode, a solid electrolyte membrane, a membrane electrode assembly (MEA), a fuel cell and a method for producing such an electrode, membrane, MEA, and fuel cell. In particular, the invention provides a method that is capable of mass-producing gas diffusion electrodes, solid electrolyte membranes, and membrane-electrode assemblies containing high-utilization, nano-structured catalyst materials for fuel cell applications.

### BACKGROUND OF THE INVENTION

Several types of fuel cells have been developed to provide efficient sources of electrical power with reduced pollution. A particularly advantageous type is the proton exchange membrane (PEM) fuel cell. A PEM fuel cell typically is composed of, among other components, two gas diffusion electrodes (GDEs) with a PEM-electrolyte being sandwiched between these two GDEs. The use of a PEM fuel cell avoids the problems of handling liquid fuels and electrolytes because it uses gaseous reactants and a solid electrolyte that allows the transfer of protons between electrodes. PEM fuel cells have been found to be reliable, efficient and convenient sources of power. However, the current PEM fuel cells are very expensive in terms of cost per kilowatt of power delivered and, hence, their practical application has been limited to specialized applications that can justify their relatively high costs, e.g., in aerospace applications. If such fuel cells are to become more widely accepted, for example as sources of vehicle power or for use in stationary power plants, the cost in terms of dollars per delivered kilowatt will have to be significantly reduced.

A major factor in determining the cost of a PEM fuel cell is the cost of the electrodes, which is, in turn, determined by a number of factors, including primarily (1) the high cost of the precious metal catalysts, which are needed for practical efficiency and (2) the cost of fabricating the electrodes, which typically involves a batch process. In addition, the cost of a fuel cell system is also indirectly affected by the electrochemical performance of the electrodes which determines the power density of the fuel cell, i.e., the power produced per unit area (e.g., kilowatts per square centimeter). It is the combination of these three factors (i.e. power density, catalyst loading, and system fabrication costs) that determines the ultimate cost per kilowatt of a complete fuel cell system. These three factors are addressed in the present invention.

A review of the prior art fuel cell technologies has indicated that current fuel cell electrodes have used unsupported platinum black, having a surface area of about 28 m²/g with a particle size of about 10 nanometers, at a catalyst loading of about 4 mg/cm² of electrode area (e.g., as disclosed in U.S. Pat. No. 4,876,115, issued in Oct. 24, 1989 to I. Raistrick). It is commonly believed in the fuel cell industry that the amount of precious metal such as platinum will have to be reduced substantially below 1 mg/cm² if PEM fuel cells are to become a widely used source of electric power.

As far as the factor of catalyst loading is concerned, it has been commonly known that the amount of precious metal catalyst can be reduced if the metal is present in a more finely divided form. For instance, electrodes using platinum supported on granular carbon particles have been used. Such supported platinum catalysts are typically prepared by chemical precipitation of the metal onto the granular support. The catalysts typically have a surface area of about 120 m²/g, with a particle size of about 2-2.5 nanometers and a catalyst loading of about 0.5 mg/cm². Although a reduced amount of the costly platinum catalyst is used in these electrodes, the power density obtained using such electrodes has remained unsatisfactory. Consequently, the cost of such a fuel cell system is still too high. The relatively poor performance, i.e., low power density, is believed to be due to an ineffective utilization of the catalyst because a substantial fraction of the platinum is not accessible to the reagents.

In U.S. Pat. No. 5,084,144, Vilambi-Reddy, et al. disclosed a method for depositing precious metal catalyst in finely divided form in a gas diffusion electrode. The method proposed by Vilambi-Reddy entails electrolytically depositing fine particles of a catalytic metal onto an un-catalyzed layer of carbon particles, which are bonded with a fluorocarbon resin and impregnated with a proton exchange resin. The gas diffusion electrodes prepared by Vilambi-Reddy, et al. contained about 0.05 mg/cm² of platinum as particles of about 3.5 nanometers in diameter having a surface area of about 80 m²/g. Such electrodes were found to function about as well as the electrodes using supported platinum with a loading of 0.5 mg/cm² of platinum. These electrodes achieved their improved mass activity, i.e., current per platinum weight, because the electrolytic process deposits the catalyst particles only at regions which are accessible by both electrons and ions in the fuel cell system. However, such improved mass activity does not compensate for the low catalyst loading provided by the process of Vilambi-Reddy, et al. Furthermore, the process of Vilambi-Reddy, et al. is tedious and expensive. As a consequence, the power density of such electrodes is still insufficient to permit the wide use of PEM fuel cells as sources of electric power.

Other attempts to reduce the costs of PEM fuel cells and to improve their performance have not been very successful. For instance, in U.S. Pat. No. 5,211,984 (May 18, 1993) M. Wilson claims that the electrode used contains supported catalyst with a loading of only 0.35 mg/cm² of platinum. But, due to the thick film (10 μm) and large platinum particles used, the catalyst efficiency has been less than satisfactory. Thick films and, hence, excessive amounts of catalyst particles are used in a membrane electrode assembly (MEA) disclosed by S. Swathirajan (U.S. Pat. No. 5,316,871). The dispersion of catalyst and carbon particles in such an assembly prepared by slurry layer pressing is not uniform, resulting in a reduced utilization efficiency of catalyst particles. In the MEA disclosed by Kosek, et al. (U.S. Pat. No. 5,523,177), the reduced (Pt—Ru)Oₓ catalyst particles are disposed across the electrode layer thickness. Such a configuration does not make efficient utilization of the catalyst particles. Furthermore, most of the prior art methods for MEA preparation produce only relatively thick MEA structures and, therefore, are not conducive to the fabrication of thin-film, integrated fuel cells. Most of the methods used are slow and/or batch processes that are expensive. For instance, the method for the electro-deposition of catalytic metals using pulsed electric fields is slow, tedious, and costly (e.g., as disclosed in U.S. Pat. No. 6,080,504 issued to E. Taylor on Jun. 27, 2000). The preparation of sputter-deposited fuel cell membranes and electrodes, as disclosed by Narayanan, et al. (U.S. Pat. No. 6,171,721, 01/09/2001), requires expensive high-vacuum equipment, which also limits the preparation to be a batch process, not amenable for continuous, mass production.

Accordingly, a need has continued to exist for a method of depositing catalytic metals or metal oxides in a gas diffusion electrode and/or PEM in desired amounts, while retaining the small particle size and electronic and ionic accessibility that provides high mass activity. A need also exists for a low-cost method of mass-producing electrodes, membrane-electrode assemblies (MEAs), and fuel cells that does not require the use of expensive high-vacuum equipment.

### SUMMARY OF THE INVENTION

A preferred embodiment of the present invention is a method for producing a thin coating of nano-structured catalytic material onto a porous substrate (a gas diffusion electrode) or a solid electrolyte membrane (including both ion-conducting oxides and proton-conducting polymers). The method includes three primary steps: (a) providing an ionized arc nozzle comprising a pair of consumable electrodes (in an elongate rod or wire form) and a working gas flow to form an ionized arc between the two consumable electrodes, wherein the consumable electrodes provide a precursor catalyst material (selected from the group consisting of a metal, metal alloy, metal compound, and ceramic material) vaporizable therefrom by the ionized arc; (b) operating the arc nozzle to heat and at least partially vaporize the precursor catalyst material for providing a stream of nanometer-sized vapor clusters of the precursor catalyst material into a chamber in which the porous electrode substrate or solid membrane is disposed; and (c) introducing a stream of a carrier gas into the chamber to impinge upon the stream of precursor vapor clusters to produce depositable nano clusters which are carried by the carrier gas to deposit onto a first side of the porous electrode substrate or solid membrane for forming the nano-structured catalyst coating.

In the case of a metal serving as a precursor material, if the carrier gas contains oxygen molecules, for instance, they will react with metal vapors to form nano-scaled oxide clusters. If other reactive gases, instead of oxygen, are used, other compound or ceramic than oxide clusters are formed to produce non-oxide nano-structured coatings. Instead, if non-reactive gases such as inert gases are introduced to impinge upon the stream of metal vapor clusters, metal-based catalytic coatings are produced.

Hereinafter, a wire refers to an elongate rod, a thin wire, a fiber, or any elongate structure of a substantially uniform cross-section. In the first step, the method begins with feeding a precursor catalyst wires of a pure metal, metal alloy, metal compound, or ceramic into the upper portion of a deposition chamber. The twin wires have their respective tips being brought closer to each other, which under a strong electric current, produce an arc in the presence of a working gas flow. The arc will heat and vaporize the wire tips to form nano-sized clusters of the catalyst precursor material. While the wire tips are being consumed by the arc, the wires are either continuously or intermittently fed into an arc zone so that the leading tips are maintained at a relatively constant position with respect to each other.

In one preferred embodiment, an oxygen-containing gas is introduced into the chamber to react with the metal vapor clusters to form metal oxide clusters. In this case, the oxygen-containing gas serves to provide the needed oxygen for initiating and propagating the exothermic oxidation reaction to form the oxide clusters in the liquid or vapor state, which are then deposited onto the substrate to form a thin coating. Several transition metal oxides are known to be very effective catalyst. In another preferred embodiment, only inert gases are used as the carrier gas and the resulting nano-structured coating is a catalytic metal. If the precursor catalyst material is a metal compound or ceramic, the resulting catalytic coating is also a compound or ceramic. The precursor material can be a pure metal, a metal alloy, a metal compound, a ceramic material, or any combination thereof.

The present invention provides a low-cost method that is capable of readily heating up the wires to a temperature as high as 6,000° C. In an ionized arc, the precursor material is rapidly heated to an ultra-high temperature and is vaporized essentially instantaneously to form atomic-, molecular-, or nanometer-scaled vapor clusters. Since the wire or rod can be continuously fed into the arc-forming zone, the arc vaporization is a continuous process, which means a high deposition rate. The atomic-, molecular-, or nanometer-scaled vapor clusters of a metal, metal compound, or ceramic material are directed to optionally pass through a heat treatment zone in such a fashion that individual clusters are deposited and bonded to the porous electrode substrate or solid membrane on the first face (catalyst-receiving surface facing the arc) of the substrate or membrane. Nano-scaled catalyst clusters are also allowed to penetrate slightly into the thickness of the electrode substrate so that they are deposited at the internal walls of the pores of a porous substrate just underneath the first face. This penetration is preferably less than half of the substrate thickness and, further preferably, less than a quarter of the substrate layer thickness.

The presently invented method is applicable to essentially all metallic materials, including pure metals and metal alloys. The precursor material can also be any metal compound or ceramic material that is vaporizable. Transition metal elements are commonly used ingredients in a catalyst system. In the practice of the present invention, the catalyst precursor material may contain at least one transition metal element selected from the group consisting of Groups IB (Cu, Ag, Au), IIB (Zn, Cd, Hg), IIIB (Sc, Y, La), IVB (Ti, Zr, Hf), VB (V, Nb, Ta), VIB (Co, Mo, W), VIIB (Mn, RE), VIII (Fe, Co, Ni, Ru, Rh, Pd, Os, Ir, Pt) elements of the Periodic Table of Elements. Rare earth metal elements are also useful catalyst materials.

In the case of a pure metal or metal alloy, the reactive gas is preferably an oxygen-containing gas, which includes oxygen and, optionally, a predetermined amount of a second gas selected from the group consisting of argon, helium, hydrogen, carbon, nitrogen, chlorine, fluorine, boron, sulfur, phosphorus, selenium, tellurium, arsenic and combinations thereof. Argon and helium are noble gases and can be used as a carrier gas (without involving any chemical reaction) or as a means to regulate the oxidation rate. Other gases may be used to react with the metal clusters to form compound or ceramic phases of hydride, oxide, carbide, nitride, chloride, fluoride, boride, sulfide, phosphide, selenide, telluride, and arsenide in the resulting coating if so desired.

If the reactive gas contains oxygen, this reactive gas will rapidly react with the metal clusters to form nanometer-sized ceramic clusters (e.g., oxides). If the reactive gas contains a mixture of two or more reactive gases (e.g., oxygen and sulphur), the resulting product will contain a mixture of oxide and sulphide clusters. If the metal composition is a metal alloy or mixture (e.g., containing both Pt and Ru elements) and the reactive gas is oxygen, the resulting product will contain ultra-fine Pt—Ru oxide clusters that can be directed to deposit onto a glass, plastic, metal, or ceramic substrate. At a high arc temperature, metal clusters are normally capable of initiating a substantially spontaneous reaction with a reactant species (e.g., oxygen). In this case, the reaction heat released is effectively used to sustain the reactions in an already high temperature environment.

The same deposition method can be used to deposit a thin layer of nano-structured catalytic material onto one face or two faces of a solid electrolyte membrane (e.g., a PEM in a PEM fuel cell or a solid oxide electrode in a high temperature solid-oxide fuel cell). The solid electrolyte membrane layer is preferably porous to allow a desired amount of depositable nano clusters to migrate into the membrane.

The present invention also provides a porous gas diffusion electrode for a fuel cell. The electrode includes (a) a gas permeable electrically conductive porous substrate layer of a known thickness having a gas-receiving face and, opposite thereto, a catalyst-supporting face; and (b) a nano-structured catalyst coating supported on the catalyst-supporting face and including a catalytic material in finely divided form in electrical contact with the catalyst-supporting face and residing in a catalyst region less than half of the layer thickness into the substrate layer from the catalyst-supporting face. The catalytic material is present in the form of ultra-fine particles having diameter of from about 2.0 nanometers to about 10 nanometers and a catalyst loading of from about 0.1 mg/cm² to about 1.0 mg/cm². These nano-scaled particles of catalytic material are deposited by the presently invented twin-wire arc deposition method.

Advantages of the present invention are summarized as follows:
1. A wide range of metals (particularly, transition metals and rare-earth metals), metal compounds and ceramic materials (including oxides) can be used as the precursor material. Furthermore, a wide variety of metallic elements can be readily converted into nanometer-scaled ceramic or compound clusters for deposition onto a solid substrate. Many compounds and ceramic materials are known to be good catalysts. In addition to oxygen, partner carrier gas species may be selected from the group consisting of hydrogen, carbon, nitrogen, chlorine, fluorine, boron, sulfur, phosphorus, selenium, tellurium, arsenic and combinations thereof to help regulate the oxidation rate and, if so desired, form respectively metal hydrides, oxides, carbides, nitrides, chlorides, fluorides, borides, sulfides, phosphide, selenide, telluride, arsenide and combinations thereof. No known prior-art technique is so versatile in terms of readily producing so many different types of metallic, compound, or ceramic catalysts on a substrate.
2. In the case of a metal material, the metal composition can be an alloy of two or more elements which are uniformly dispersed. When broken up into nano-sized clusters, these elements remain uniformly dispersed and are capable of reacting with oxygen to form uniformly mixed oxide particles. No post-fabrication mixing treatment is necessary. Some bimetallic catalysts are known to provide good catalytic effects.
3. Each wire can be fed into the arc zone at a high rate with its leading tip readily vaporized. This feature makes the method fast and effective and now makes it possible to mass produce catalytic coatings on a substrate (either a gas diffusion electrode or a solid electrolyte membrane) cost-effectively. Both a catalytic electrode and a solid electrolyte layer can be made by using the same method.
4. The system needed to carry out the invented method is simple and easy to operate. It does not require the utilization of heavy and expensive equipment such as a laser or vacuum-sputtering unit. This feature also makes it possible to undergo roll-to-roll productions, which are fast and continues. In contrast, it is difficult for a method that involves a high vacuum to be a continuous process. The over-all product costs produced by the presently invented vacuum-free method are very low.

It may be noted that in an earlier, commonly own patent application (“Electrode, Membrane Electrode Assembly, Fuel Cell and Method for Their Production,” U.S. Pat. application Ser. No. 10/105,474, filed on Mar. 26, 2002), Huang and Wu disclosed a vapor cluster deposition method that made use of a consumable electrode and an un-consumable electrode. This application is herein presented as a reference.

### BRIEF DESCRIPTION OF THE DRAWINGS

FIG. 1 schematic of a fuel cell composed of a gas-diffusing anode 17 (containing a thin layer 16 of electro-catalyst), an electrolyte layer 14, a gas-permeable cathode 19 (containing an electro-catalyst layer 18).

FIG. 2 schematic of another fuel cell in which the electrolyte layer 15 and two thin layers of electro-catalyst deposited from its two major surfaces inward form a membrane-electrode assembly.

FIG. 3 shows the schematic of a system that can be used in the practice of a preferred embodiment of the presently invented twin-wire arc deposition method for producing a catalyst coating on a solid substrate.

FIG. 4 shows the schematic of another system (with an additional plasma zone to help fully vaporize the precursor material) that can be used in the method for producing catalyst coating on a substrate.

FIG. 5 schematically shows one way to prepare a membrane electrode assembly (MEA). (A) a solid electrolyte is provided, (B) one side 32 of this electrolyte layer is exposed to depositable catalytic clusters, (C) another side 34 of this electrolyte layer is exposed to depositable catalytic clusters, and (D) the resulting catalyst-bearing electrolyte layer is laminated with a fuel gas permeable electrode 35 and an air permeable electrode 36 to form a basic assembly which may be sandwiched between two respective flow field/current collector plates to form a complete fuel cell.

FIG. 6 shows that the presently invented twin-wire arc deposition method is amenable to roll-to-roll production of catalyst-coatings.

FIG. 7 shows that the presently invented twin-wire arc deposition method can be integrated with electrode-dispensing and bonding operations to mass-produce basic fuel cell assemblies.

### DETAILED DESCRIPTION OF PREFERRED EMBODIMENTS

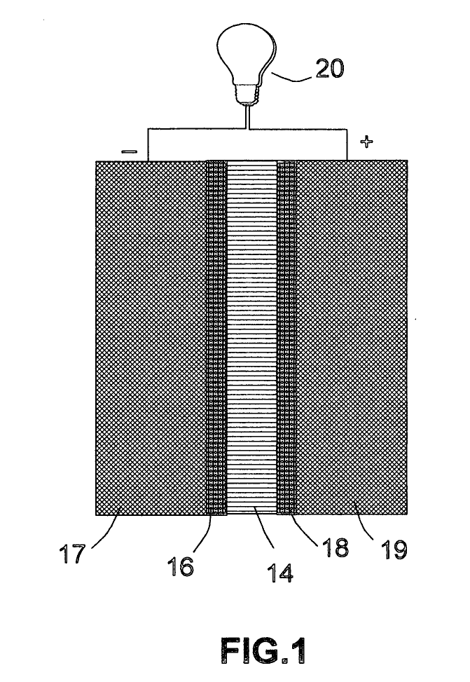

FIG. 1 schematically shows a basic fuel cell structure. This is a proton exchange membrane (PEM) fuel cell that is composed of a gas-permeable or gas diffusion anode 17 (containing a thin layer 16 of electro-catalyst), a PEM-based electrolyte layer 14, and a gas-permeable cathode 19 (containing an electro-catalyst layer 18). Fuel gases (e.g., hydrogen) that enter from the anode 17 undergo an anode reaction (H₂→2H⁺+2e⁻) under the catalytic action of the electro-catalyst 16. The produced electrons go out to power an external load (e.g., a bulb 20). The produced protons H⁺ migrate into and through the proton exchange membrane and react with oxygen (that comes in from the cathode 19) to produce water molecules (½O₂+2H⁺+2e^{-→2}H₂O). This cathode reaction is catalyzed by the electro-catalyst 18 deposited onto or into a surface of the cathode. The two catalyst layers 16,18 are prepared by a method to be described later. In FIG. 1, the catalyst layer (16 or 18) is preferably less than ½ and further preferably less than ¼ of the corresponding gas-diffusion electrode layer thickness.

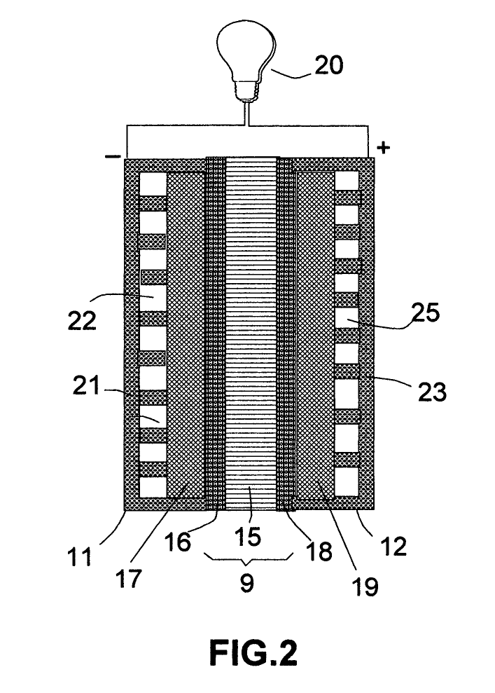

FIG. 2 schematically shows a more common configuration for a fuel cell. The anode flow field plate 11 has fuel flow channels (e.g., 22) that direct fuel gases to flow through an electro-catalyst layer 16, which is bonded to or integral with an electrolyte layer 15. The catalytic material is allowed to permeate into the bulk of the electrolyte layer during the catalyst deposition step. This penetration of the catalyst into the electrolyte is preferably less than ½ and further preferably less than ¼ of the electrolyte layer thickness. The anode flow field plate 11 also has a current collector plate or grid 21 which is electronically conducting. The cathode flow field plate 12 has a current collector 23 and air flow channels (e.g., 25) that direct the migration of oxygen gases through an electro-catalyst layer 18, which serves to promote cathode reactions. The cathode catalyst layer 18 is also bonded to or integral with the solid electrolyte layer 15. The cathode catalyst layer 18 is preferably less than ½ of the electrolyte layer thickness and further preferably less than ¼ of the electrolyte layer thickness. The anode electro-catalyst layer 16, the solid electrolyte layer 15, and the cathode electro-catalyst layer 18 are collectively referred to as a membrane-electrode assembly 9 (MEA).

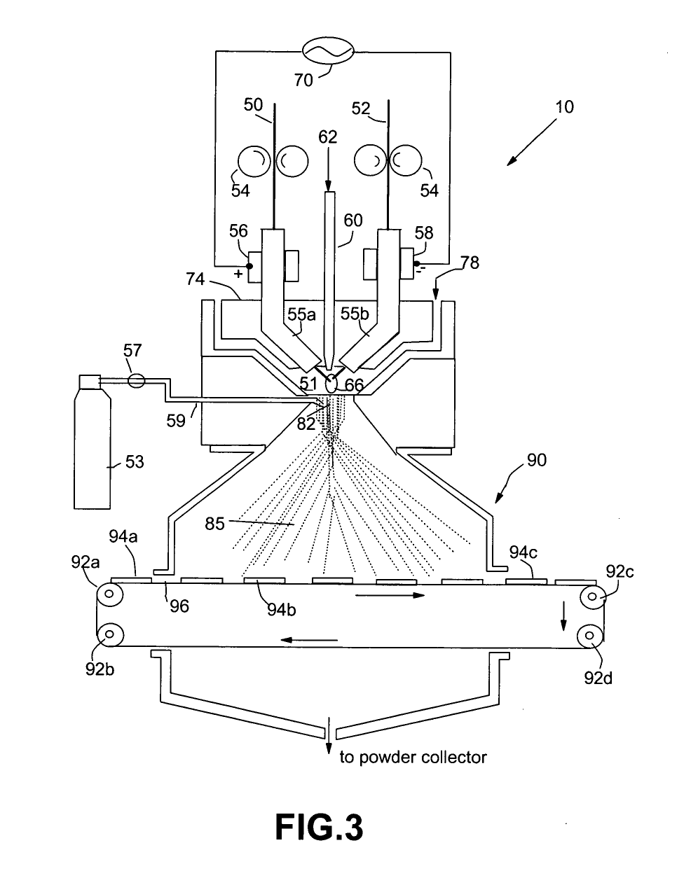

The present invention provides a method for fabricating a membrane for use in a fuel cell membrane electrode assembly. The method includes the steps of (A) preparing a solid electrolyte membrane, wherein the membrane has an eventual anode side and an eventual cathode side; and (B) twin-wire arc-depositing at least one catalyst onto at least one of the eventual anode side and the eventual cathode side of the solid electrolyte membrane. This twin-wire arc deposition method is illustrated in FIG. 3.

FIG. 3 schematically shows a twin-wire arc-induced vapor cluster deposition system that can be used in practicing the invented “twin-wire arc deposition” method for producing a nano-structured catalyst coating onto a solid substrate such as an electrode or a solid electrolyte layer. This apparatus includes four major functional components: (1) a coating chamber 90, (2) a twin-wire arc nozzle means 10, (3) reactive gas-supplier (e.g., a gas bottle 53 supplying a reactive gas through a valve 57 and pipe means 59 into a location inside the chamber downstream from the ionized arc 66), and (4) substrate supporter-conveyor (e.g., conveying rollers 92a,92b,92c,92d and belt 96).

In a preferred embodiment of the presently invented system, as indicated in FIG. 3, the twin-wire electric arc deposition nozzle is mainly composed of an electrically insulating block 74, two feed wires 50, 52, a working gas passage means 60, and an optional secondary gas nozzle with a gas passage 78. The two metal wires 50,52 are supplied with a DC voltage (one “+” and the other “−”) or a pulsed power 70 to form an arc 66 in an arc chamber 51. This arc 66, being at an ultra-high temperature (up to 6,000° C.), functions to melt and vaporize the wire tips to generate nano-sized vapor clusters from the consumable wires, which are composed of a precursor catalyst material such as a metal, a metal compound, a ceramic, or a combination thereof. A stream of working/carrier gas from a source 62 (not shown; denoted by an arrow) passes through the passage means 60 into the arc chamber 51 to help maintain the ionized arc and to carry the stream of vapor clusters downward toward lower portion of the coating chamber 90.

The two wires 50,52 can be fed through air-tight means 55a,55b into the arc cell 51, continuously or intermittently on demand, by a wire-feeding device (e.g., powered rollers 54). The roller speed may be varied by changing the speed of a controlling motor. An optional secondary gas nozzle (having a gas passage 78) can be used to further increase the arc temperature, providing a stream of super-heated ultra-fine metal vapor clusters into the coating chamber 90. Alternatively, this secondary gas nozzle may be an atomizing nozzle such as a vortex nozzle that uses a high-speed gas to atomize the un-vaporized melt generated at the arc zone 66.

A reactive gas such as an oxygen-containing gas provided from a gas cylinder 53 goes through a gas regulator or control valve 57 and tubing 59 into a location 82 downstream from the ionized arc 66 inside the coating chamber. The gas regulator or control valve 57 is used to adjust the gas flow rate as a way to vary the effective coating rate. When the precursor catalyst material is a metal or metal alloy, the oxygen gas impinges upon the metal vapor clusters to initiate and sustain an exothermic oxidation reaction between oxygen and metal clusters, thereby converting the ultra-fine metal clusters into depositable metal oxide clusters 85 that are in the liquid or, preferably, vapor state.

The ultra-fine oxide clusters 85 are then directed to deposit onto an electrode backing plate or a solid electrolyte membrane (e.g., 94b) being supported by a conveyor belt 96 which is driven by 4 conveyor rollers 92a-92d. The lower portion of FIG. 3 shows a train of backing or membrane pieces, including 94a (un-coated), 94b (being coated) and 94c (coated). The oxide clusters that are not deposited will be cooled to solidify and become solid powder particles. These powder particles, along with the residual working gas and carrier gas, are transferred through a conduit to an optional powder collector/separator system (not shown).

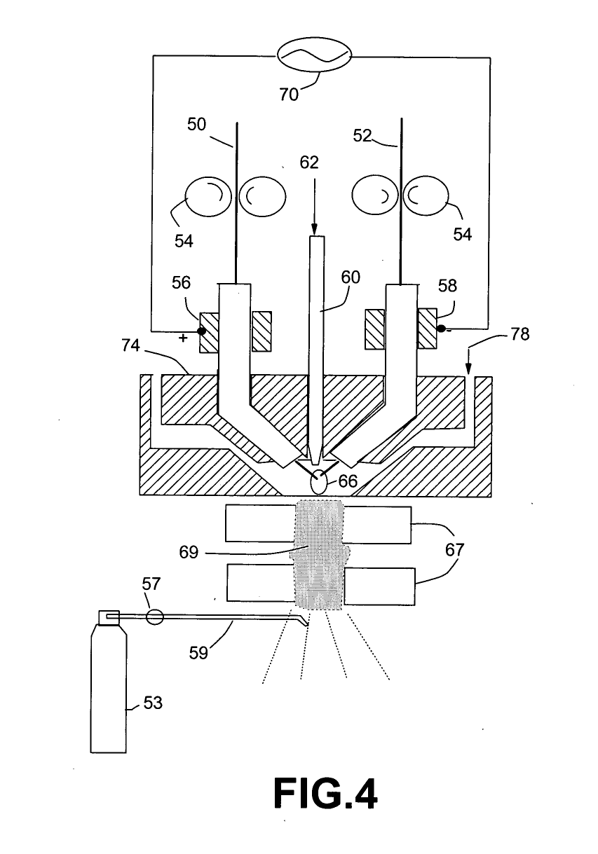

The twin-wire arc spray nozzle, originally developed for use in a conventional thermal spray coating process, can be adapted for providing a continuous stream of super-heated vapor clusters. This low-cost device, is capable of readily heating up the metal wire to a temperature as high as 6,000° C., sufficient to vaporize most of the metal, metal compound, and ceramic materials (such as oxides) that are commonly used as catalysts. In the cases where some of the precursor catalyst material from the wire tips is melted but not vaporized, the step of operating an arc nozzle means to heat and at least partially vaporize the precursor catalyst material to form a stream of precursor catalyst vapor clusters could include the sub-steps of melting the precursor catalyst material and atomizing the resulting metal melt to form nanometer-scaled liquid droplets of the precursor material. The liquid droplets could become mixed with the stream of vapor clusters. Atomization gas could come from the gas passage 78 as shown in FIG. 3 or FIG. 4.

Twin-arc spray nozzles have been advanced to the extent that they provide reliable and stable ultra-high temperature arcs. These low cost devices are available from several commercial sources. The carrier gas from the gas bottle 53 may comprise non-reactive noble gases such as argon or helium and the wires may comprise metals or metal alloys. The resulting catalyst coating will remain to be metals or metal alloys, not oxides, compounds, or ceramics. This is particularly useful for the deposition of noble metal catalyst from Pt and Au. A non-reactive gas may also be used to modulate or truncate the arc flame size, or simply to adjust the arc flame temperature.

In another embodiment of the invented system, the two wires are made up of two different materials so that a mixture of two types of nano clusters can be produced for the purpose of depositing a hybrid or composite coating material.

It may be noted that the twin-wire arc deposition method clearly is capable of depositing a catalyst coating onto a surface of a solid electrolyte membrane layer as well as a surface of an electrode backing layer (gas diffusion layer). It is also capable of depositing a solid oxide electrolyte membrane layer onto a solid substrate such as a catalyst-coated backing layer in a solid-oxide fuel cell.

In a preferred embodiment, the system (for both cases of two wires of the same material and of different materials) as defined above may further include a second plasma arc zone below the ionized arc between the two wire tips to vaporize any un-vaporized material dripped therefrom. For instance, a plasma arc device (e.g., with electrodes 67 in FIG. 4) may be utilized to generate a plasma arc zone 69 through which the un-vaporized melt droplets dripped out of the ionized arc 66 will have another chance to get vaporized. The creation of a plasma arc zone is well-known in the art. The ultra-high temperature in the plasma arc (up to as high as 32,000° K.) rapidly vaporizes the melt droplets that pass through the plasma arc zone.

For the purpose of clearly defining the claims, the word “wire” means a wire of any practical diameter, e.g., from several microns (a thin wire or fiber) to several centimeters (a long, thick rod). A wire can be supplied from a spool, which could provide an uninterrupted supply of a wire as long as several miles. This is a very advantageous feature, since it makes the related coating process a continuous one that is amenable for low-cost, mass production.

The arc 66, being at an ultra-high temperature (up to 6,000° C.), functions to melt and vaporize the wire tip of the precursor material to generate nano-sized vapor clusters. A stream of working gas from a source 62 exits out of the orifice of a tube 62 into the arc chamber 51 to help maintain the ionized arc and to carry the stream of vapor clusters generally downward toward the lower portion of the coating chamber 90. Preferably, the working gas flow and the reactive gas are directed to move in a general direction toward the solid substrate (e.g. 94b) to be coated. In FIG. 3. as an example, this direction is approximately vertically downward.

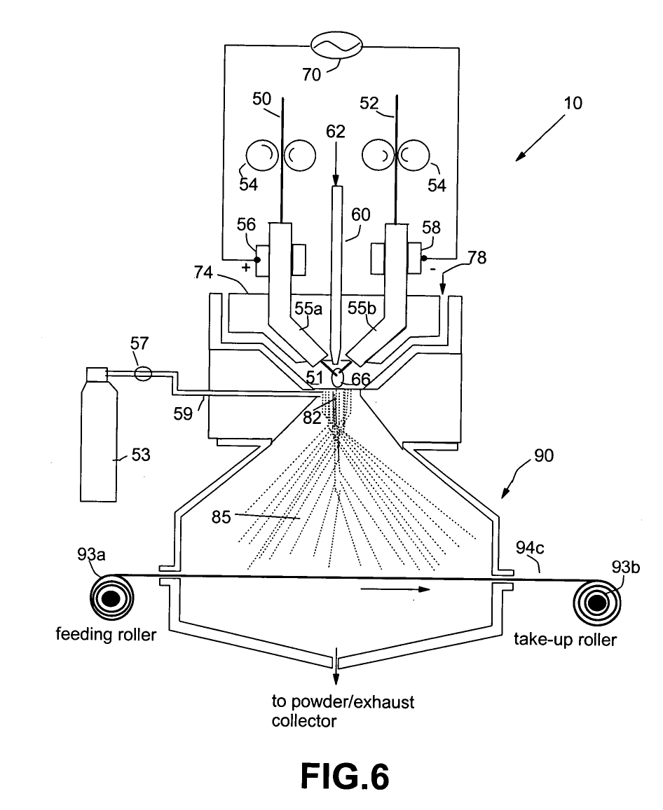

The ultra-fine vapor clusters 85 are then directed to deposit onto a solid electrode or electrolyte membrane substrate (e.g., 94b) being supported by a conveyor belt 96 which is driven by 4 conveyor rollers 92a-92d. The lower portion of FIG. 3 shows a train of substrate pieces, including 94a (un-coated), 94b (being coated) and 94c (coated). Advantageously, as shown in FIG. 6, an electrode backing material (e.g., carbon paper or fabric) or a solid polymer electrolyte film may be fed from a feeding roller 93a, moved into the coating chamber 90, surface-coated with a thin catalyst layer, moved out of the chamber 90, and then wound around a take-up roller 93b. Because no high vacuum condition is required of the invented method, a continuous roll-to-roll production of catalyst-coated membrane or electrode layers is now possible.

Optionally, the chamber may be equipped with a heat treatment zone that serves to change the temperatures of the vapor clusters so that a desired proportion of the clusters remain in a vapor or liquid state. The temperature and physical state of the depositable clusters govern if these clusters are (a) deposited as individual nano particles that stick to the substrate material at their points of contact or (b) spread up to become nano-sized thin film domains that partially cover the substrate. If so desired, the clusters with proper heat treatments (e.g., cooling) may become a mixture of solid particles and/or liquid droplets and/or vapor clusters prior to striking onto the substrate surface. The liquid droplets and/or vapor clusters act to glue or bond together otherwise separate individual solid particles, still leaving behind a desired amount of minute pores. Since the clusters are nanometer-scaled, the resulting pores are also nanometer-scaled. In the case where all clusters remain in the liquid or vapor state just prior to impinging upon the substrate, the resulting coating tends form relatively film-like, nano-scaled catalyst domains.

The vapor clusters that are not deposited onto a substrate will be cooled to solidify and become solid powder particles. These powder particles, along with the residual gases, are transferred through a conduit to an optional powder collector/separator system (not shown).

In another embodiment of the invented system, the wire or rod is made up of two metal elements so that a mixture of two types of nano clusters can be produced for the purpose of depositing a hybrid or composite catalyst material (e.g., a platinum-transition metal based bi-metallic catalyst).

The presently invented method is applicable to essentially all metallic materials (including pure metals and metal alloys), metallic compounds and ceramic materials. As used herein, the term “metal” refers to an element of Groups 2 through 13, inclusive, plus selected elements in Groups 14 and 15 of the periodic table. Thus, the term “metal” broadly refers to the following elements:
Group 2 or IIA: beryllium (Be), magnesium (Mg), calcium (Ca), strontium (Sr), barium (Ba), and radium (Ra).
Groups 3-12: transition metals (Groups IIIB, IVB, VB, VIIB, VIIB, VII, IB, and IIB), including scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), zinc (Zn), cadmium (Cd), and mercury (Hg).
Group 13 or IIIA: boron (B), aluminum (Al), gallium (Ga), indium (In), and thallium (TI).
Lanthanides: lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).
Group 14 or IVA: germanium (Ge), tin (Sn), and lead (Pb).
Group 15 or VA: antimony (Sn) and bismuth (Bi).

For fuel cell applications where hydrogen splitting or oxygen catalyzing is needed, the group consisting of transition metals is most desirable. Noble metal elements such as Pt, Pd, and Au are very effective catalysts, so are some rare-earth metals and most of the transition metal oxides.

Preferably the reactive gas includes oxygen and a gas selected from the group consisting of hydrogen, carbon, nitrogen, chlorine, fluorine, boron, iodine, sulfur, phosphorus, arsenic, selenium, tellurium and combinations thereof. Noble gases such as argon and helium may be used to adjust or regulate the oxidation rate. Other gases may be used to react with metal clusters to form nanometer-scale compound or ceramic powders of hydride, oxide, carbide, nitride, chloride, fluoride, boride, iodide, sulfide, phosphide, arsenide, selenide, and telluride, and combinations thereof. The method may further include operating means for providing dissociable inert gas mixable with the working gas. The dissociable inert gas serves to increase the temperature gradient in the ionized arc. The stream of reactive gas reacts with the vapor clusters in such a manner that the reaction heat released is used to sustain the reaction until most of the precursor vapor clusters are substantially converted to nanometer-sized metal compound or ceramic clusters. The stream of reactive gas is preferably pre-heated to a predetermined temperature prior to being injected to impinge upon the precursor vapor clusters. A higher gas temperature promotes or accelerates the conversion of metallic clusters to compound or ceramic clusters.

If the carrier gas injected contains a reactive gas (e.g., oxygen), this reactive gas will rapidly react with the precursor material clusters to form nanometer-sized ceramic clusters (e.g., oxides). If the reactive gas contains a mixture of two or more reactive gases (e.g., oxygen and sulphur), the resulting product will contain a mixture of two compounds or ceramics (e.g., oxide and sulphide). If the metal wire is a metal alloy or mixture (e.g., containing both nickel and copper elements) and the reactive gas is oxygen, the resulting product will contain ultra-fine nickel-copper oxide particles.

In summary, a preferred embodiment of the present invention is a method for producing a nano-porous catalyst coating onto a solid substrate such as a fuel cell electrolyte or electrode backing layer. The method includes the following steps: (a) providing an ionized arc nozzle that includes two consumable electrodes and a working gas flow to form a first ionized arc between the two electrodes, wherein the consumable electrodes provide a precursor material vaporizable from the consumable electrodes by the ionized arc; (b) operating the arc nozzle to heat and at least partially vaporize the precursor material for providing a stream of nanometer-sized vapor clusters into a chamber in which the substrate is disposed; (c) introducing a stream of gas (reactive, non-reactive, or both) into the chamber to impinge upon the stream of precursor vapor clusters and exothermically react therewith to produce substantially nanometer-sized metal compound or ceramic clusters (e.g., oxide clusters, if oxygen exists); and (d) directing the clusters to deposit onto the substrate for forming the nano-porous catalyst coating.

The optional step of operating heat treatment means may include a step of injecting a stream of cool gas to impinge upon the vapor clusters in such a fashion that a non-zero proportion of the vapor clusters are converted into solid clusters being at a temperature sufficient to cause partial sintering between individual solid clusters. The step of operating heat treatment means may be carried out in such a fashion that the vapor clusters are converted to become a mixture of solid clusters and liquid clusters or a mixture of solid, liquid, and vapor clusters. The resulting catalyst coatings obtained under these conditions were found to be nano-grained and nano-porous.

In the presently invented method, the step of operating an arc nozzle means to heat and at least partially vaporize the wire of a precursor composition may include a sub-steps of melting the wire and atomizing the resulting metal melt to form nanometer-scaled liquid droplets of the precursor material. The liquid droplets are mixed with or become a part of the stream of vapor clusters. Atomization produces ultra-fine droplets that promote vaporization of the precursor material melt and accelerate the reaction between the precursor material and the reactive gas injected into the arc zone. The liquid droplets readily react with the reactive gas to form nano-scaled metal compound or ceramic clusters.

Preferably, as shown in FIG. 3, the solid substrate in the practice of the present method includes a train of individual pieces (e.g., 94a, 94b, 94c) of an electrode or electrolyte solid being moved sequentially or concurrently into coating chamber and then moved out of the chamber after the coating is formed. This feature will make the process a continuous one.

In a preferred embodiment of the present invention, an electrode (e.g. a cathode) may contain a porous gas diffusion layer that comprises carbon and/or oxide particles. These particles may be bonded together by a resin or adhesive to form a porous structure. These carbon and/or oxide particles may be bonded to a fibrous substrate such as a non-woven fabric. The gas diffusion layer or electrode backing layer is coated with a thin layer of electro-catalyst using the presently invented twin-wire arc deposition method. Similarly, the same method may be repeated to produce a catalyst-coated backing layer, which may then be bonded to one side of a solid electrolyte, the other side of which is bonded to a catalyst-coated cathode backing. By adding flow filed plates/current collectors to the two backing layers one obtains a complete fuel cell structure.

Hence, in another preferred embodiment, the present invention provides a method for forming an electrode for use in a fuel cell membrane electrode assembly comprising the steps of: (A) preparing a precursor material to a catalyst, with the precursor catalyst material being in an elongate rod or wire form; (B) preparing a backing that includes multiple sides; and (C) twin-wire arc-depositing the catalyst onto the multiple sides of the backing.

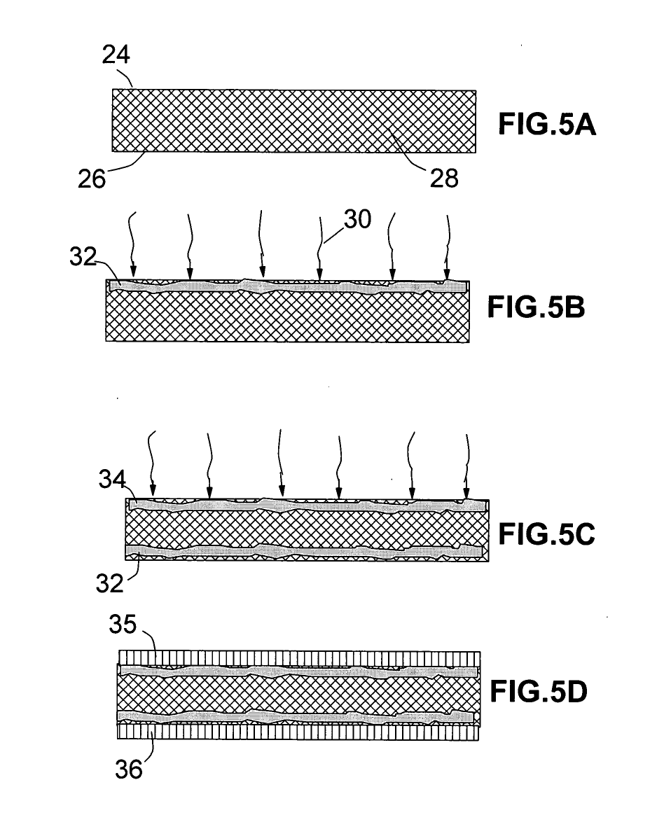

In a further preferred embodiment, the solid electrolyte layer may comprise either a proton exchange membrane (PEM) for a PEM-based fuel cell or a solid oxide electrolyte phase for a high temperature solid oxide fuel cell. For instance, as schematically shown in FIG. 5A-5D, a porous solid oxide electrolyte layer (28 in FIG. 5A) has two major surfaces: a first surface 24 and a second surface 26. The electrolyte layer may be placed in the deposition chamber (e.g., in FIG. 3) with the first surface 24 facing up to receive depositable clusters 30 which penetrate slightly into the bulk of the electrolyte layer to form a catalyst layer 32 (FIG. 5B). This is followed by turning the electrolyte layer upside down and depositing an electro-catalyst layer 34 to the second surface 26 of this solid electrolyte layer (FIG. 5C). The three layers 32, 28, and 34 form a membrane electrode assembly (MEA). This assembly is then sandwiched between two gas permeable electrode backing layers 35 and 36 to form a basic assembly (FIG. 5D). This assembly may be combined with other components such as flow field plates/current collector grids and cell casing to form a fuel cell.

Another preferred embodiment of the present invention is a fuel cell membrane electrode assembly comprising an ion-conducting electrolyte membrane sandwiched between two electrodes wherein at least one of the electrodes is a porous gas diffusion electrode which contains a nano-structured electro-catalyst layer prepared by the presently invented twin-wire arc deposition method. This nano-structured catalytic coating layer is in electric contact with an electrolyte membrane. Preferably, this membrane is a proton exchange membrane.

Still another embodiment is a fuel cell that contains at least one of the above-defined MEAs or one of the above-defined porous gas diffusion electrode bearing an electro-catalyst layer prepared by the presently invented twin-wire arc deposition method. Hence, specifically, this embodiment includes a fuel cell comprising: (A) an anode electrode; (B) a cathode electrode; (C) a fuel supply; and (D) an electrolyte membrane comprising a solid electrolyte, wherein the membrane has a first side adjacent the anode electrode and a second side adjacent the cathode electrode, and wherein the electrolyte membrane further comprises a twin-wire arc-deposited catalyst on at least one of the first and second sides thereof. The twin-wire arc-deposited catalyst has a porosity effective for sustaining a voltage and gas flow across a membrane electrode assembly in the fuel cell. Alternatively, a catalyst layer may be deposited onto at least an electrode backing layer before this backing layer is incorporated in a fuel cell structure.

Further specifically, still another preferred embodiment of the present invention is a catalytic solid electrolyte membrane for a fuel cell. This membrane is characterized by comprising: (a) an ion-conducting solid electrolyte substrate layer of a known thickness having a first face and, opposite thereto, a second face; and (b) a nano-structured catalyst coating supported on the first major face and comprising a catalytic material in finely divided form in electrical contact with the first face and residing in a catalyst region less than a quarter of the layer thickness into the substrate layer from the first face. Specifically, the catalytic material is present in the form of ultra-fine particles having diameter of from about 2.0 nanometers to about 10 nanometers and the catalyst loading of from about 0.05 mg/cm² to about 1.0 mg/cm². Preferably, this solid electrolyte membrane further comprises a catalyst coating supported on its second major face. These particles of catalytic material are deposited by the vapor cluster deposition method. These particles reflect the best utilization of catalyst materials.

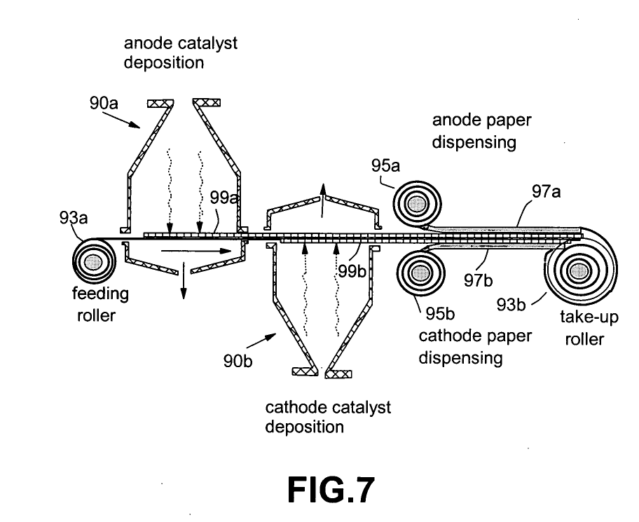

Another preferred embodiment of the present invention is a fuel cell production method that combine the presently invented twin-wire arc deposition operations with other operations (such as dispensing of carbon paper backing layers, bonding of the carbon paper layers to the MEAs produced by the twin-wire arc deposition process, etc.) to mass-produce fuel cell structures. As illustrated in FIG. 7, this integrated fuel cell production method could begin with feeding a polymer electrolyte membrane from a roller 93a into a first twin-wire arc deposition chamber 90a in which a thin anode catalyst layer 99a is coated onto the top surface of the polymer membrane. The anode catalyst-coated electrolyte membrane is then moved into a second twin-wire arc deposition chamber 90b in which a thin cathode catalyst layer is deposited onto the bottom surface of the membrane to form a membrane-electrode assembly (MEA). This three-layer MEA is moved out of the second deposition chamber 90b into a backing layer bonding zone where two rollers 95a, 95b of carbon-paper or carbon-cloth backing materials feed one backing layer 97a above the MEA and another backing layer 97b below the MEA to combine with the MEA for forming a basic five-layer fuel cell assembly structure. This five-layer structure may be wound around a take-up roller 93. In this integrated production system, one roller may be a driving roller and the other a driven roller.

This roll of five-layer structure may be later cut and trimmed into individual pieces, which are combined with two flow field/current collector plates (to make a seven-layer structure) and a casing to form a complete fuel cell. Several individual seven-layer structures may be electrically connected in series, in parallel, or both to provide desired voltage, current and power output levels. This is a very cost-effective method for mass-producing fuel cells.

### EXAMPLE 1

Metal rods of Cu, Fe, Ti, Ni, Pt and Au each of 1/8 inches diameter were used as a precursor catalyst material. This arc electrodes were shielded by 25-100 cfh of a working gas of argon combined with 5-100% nitrogen and/or 5-50% hydrogen. The current of the arc was adjusted between approximately 100 and 450 amps, which generated an arc tail flame 1-4 inches long that evaporated the precursor catalyst material. The arc created a stream of metal vapor clusters of 1-200 g/hr while an argon flow of 10-1000 cfh was injected into the tail flame to carry the metal vapor clusters toward a non-woven carbon fiber layer (as a porous air-permeable fuel cell anode). The micro-structure of the resulting catalyst layer was typically characterized by exhibiting catalyst particle sizes in the range of 1-20 nm.

### EXAMPLE 2

Metal rods of Ru-coated Cu, Fe, Ti, and Ni each of 1/8 inches diameter were used as a precursor catalyst material. This arc cathode was shielded by 25-100 cfh of a working gas of argon combined with 5-100% nitrogen and/or 5-50% hydrogen. The current of the arc was adjusted between approximately 100 and 450 amps, which generated an arc tail flame 1-4 inches long that evaporated the precursor catalyst material. The arc created a stream of metal vapor clusters of 1-200 g/hr while an oxygen flow of 10-1000 cfh was injected into the tail flame to form oxide clusters of the starting metal. These oxide clusters were directed to deposit onto a porous copper plate to form a catalytic oxide layer therein. The micro-structure of the resulting catalyst coatings was typically characterized by particle sizes in the range of 1-15 nm. These transition metal oxide nano particles are effective fuel cell cathode catalysts.

### EXAMPLE 3

The same precursor catalyst metals and same deposition procedures as in EXAMPLE 2 were used to deposit an oxide based catalyst layer onto two major surfaces of a solid oxide electrolyte, which was yttrium oxide stabilized zirconium oxide (YSZ). This solid electrolyte layer was sandwiched between two porous electrodes that were composed of a mixture of YSZ and nickel metal to make a membrane-electrode assembly for a solid oxide fuel cell.

### EXAMPLE 4

NAFION®-117 was cast into a membrane using known methods. The hydrated membrane was allowed to air dry for 24 hours and then vacuum dried from about 12 hours. The vacuum-dried membrane was weighed and secured in a substrate holder of a twin-wire arc deposition chamber with the eventual anode side of the membrane being exposed. Ruthenium-coated platinum wires were used as the catalyst precursor material. The membrane was twin-wire arc-deposited for 10-600 seconds with a current of 200 amps. The membrane was then re-weighed. The catalyst coating was 0.05-1 mg/cm² of the anode side of the membrane.

A carbon paper carrier was secured in the chamber as described above. The carrier was coated with 0.5 mg/cm² of the platinum-ruthenium material according to the methods used above to coat the membrane. A cathode electrode was assembled using known techniques.

The membrane and electrodes were then assembled into a membrane electrode assembly, which was then combined with other layers to make a seven-layer direct-methanol fuel cell using known hot-pressing techniques at 140-150° C.

1. A method for fabricating a membrane for use in a fuel cell membrane electrode assembly comprising the steps of:
(A) preparing a solid electrolyte membrane, wherein the membrane has an eventual anode side and an eventual cathode side; and
(B) twin-wire arc-depositing at least one catalyst onto at least one of the eventual anode side and the eventual cathode side of said solid electrolyte membrane.

2. The method of claim 1, wherein said twin-wire arc depositing of said catalyst results in a deposited catalyst weight from about 0.05 mg of catalyst per square centimeter of said electrolyte membrane to about 1.0 mg of catalyst per square centimeter of said electrolyte membrane.

3. The method of claim 1, wherein said catalyst is twin-wire arc-deposited to the eventual anode side of said electrolyte membrane and said catalyst is twin-wire arc-deposited to the eventual cathode side of said electrolyte membrane.

4. The method of claim 1, wherein said step of preparing a solid electrolyte membrane comprises twin-wire arc depositing a porous solid layer to a solid substrate.

5. The method of claim 1, wherein said twin-wire arc depositing step comprises depositing a nano-structured catalyst coating onto said membrane from a precursor catalyst material selected from the group consisting of a metal, metal alloy, metal compound, and ceramic material, said step comprising the sub-steps of:
(a) providing an ionized arc nozzle means comprising two consumable electrodes in an elongate rod or wire form and a working gas flow to form an ionized arc between said two consumable electrodes, wherein said consumable electrodes provide said precursor catalyst material vaporizable therefrom by said ionized arc;
(b) operating said arc nozzle means to heat and at least partially vaporize said precursor catalyst material for providing a stream of nanometer-sized vapor clusters of said precursor catalyst material into a chamber in which said membrane is disposed; and
(c) introducing a stream of a carrier gas into said chamber to impinge upon said stream of precursor vapor clusters to produce depositable nano clusters which are carried by said carrier gas to deposit onto a first side of said membrane for forming said nano-structured catalyst coating.

6. The method of claim 5, wherein said carrier gas comprises a reactive gas that reacts with said precursor vapor clusters for producing said depositable nano clusters which are metal compounds or ceramic materials.

7. The method as set forth in claim 5, further comprising a sub-step of operating at least a second ionized arc nozzle means to completely vaporize said precursor catalyst material.

8. The method as set forth in claim 5, wherein said precursor material comprises at least one transition metal element selected from the group consisting of Groups IB, IIB, IIIB, IVB, VB, VIB, VIIB, and VIII elements of the Periodic Table of Elements, wherein said Group IB includes Cu, Ag, and Au; Group IIB includes Zn, Cd, and Hg; Group IIIB includes Sc, Y, and La, Group IVB includes Ti, Zr, and Hf; Group VB includes V, Nb, and Ta; Group VIB includes Co, Mo, W; Group VIIB includes Mn and Re; and Group VIII includes Fe, Co, Ni, Ru, Rh, Pd, Os, Ir, and Pt.

9. The method as set forth in claim 6, wherein said stream of reactive gas comprises a gas selected from the group consisting of hydrogen, oxygen, carbon, nitrogen, chlorine, fluorine, boron, sulfur, phosphorus, selenium, tellurium, arsenic vapor and combinations thereof.

10. The method as set forth in claim 5, wherein said carrier gas comprises an inert gas.

11. The method as set forth in claim 5, wherein said membrane comprises a train of individual pieces of solid electrolyte membrane material being moved sequentially or concurrently into said chamber and then moved out of said chamber after said coating is formed.

12. The method as set forth in claim 1, wherein said membrane comprises an oxide structure that is ion-conducting.

13. The method as set forth in claim 1, wherein said solid electrolyte membrane comprises an ion exchange polymer that is ion-conducting.

14. The method as set forth in claim 5, wherein said precursor material comprises an alloy of at least two metallic elements.

15. The method as set forth in claim 5, wherein said stream of carrier gas contains a reactive gas that reacts with said precursor catalyst vapor clusters in such a manner that the reaction heat released is used to sustain the reaction until most of said precursor vapor clusters are substantially converted to nanometer-sized metal compound or ceramic clusters.

16. The method as set forth in claim 5, wherein said stream of carrier gas is pre-heated to a predetermined temperature prior to being injected to impinge upon said precursor vapor clusters.

17. The method as defined in claim 5, wherein the step of operating an arc nozzle means to heat and at least partially vaporize the precursor catalyst material to form a stream of precursor catalyst vapor clusters includes the sub-steps of melting the precursor catalyst material and atomizing the resulting metal melt to form nanometer-scaled liquid droplets of said precursor material, said liquid droplets becoming mixed with said stream of vapor clusters.

18. The method as defined in claim 17, wherein said liquid droplets react with said reactive gas to form nano-scaled metal compound or ceramic clusters.

19. The method of claim 1, wherein a first catalyst is deposited on the eventual anode side of the electrolyte membrane and a second catalyst is deposited on the eventual cathode side of the electrolyte membrane, and the first catalyst differs from the second catalyst.

20. A method for forming an electrode for use in a fuel cell membrane electrode assembly comprising the steps of:
(A) preparing a precursor material to a catalyst, said precursor catalyst material being in an elongate rod or wire form;
(B) preparing a backing that includes multiple sides; and
(C) twin-wire arc-depositing said catalyst onto said multiple sides of said backing.

21. The method of claim 20, wherein said backing comprises carbon paper or carbon cloth.

22. The method of claim 20, wherein said twin-wire arc depositing of said catalyst results in a deposited catalyst weight from about 0.05 mg of catalyst per square centimeter of said backing to about 1.0 mg of catalyst per square centimeter of said backing.

23. The method of claim 20, wherein said catalyst is deposited to an anode electrode, a cathode electrode, or both.

24. The method of claim 20, wherein said step of preparing a backing comprises twin-wire arc depositing a porous solid layer onto a solid substrate.

25. The method of claim 20, wherein said twin-wire arc depositing step comprises depositing a nano-structured catalyst coating onto said backing from a precursor catalyst material selected from the group consisting of a metal, metal alloy, metal compound, and ceramic material, said step comprising the sub-steps of:
(a) providing an ionized arc nozzle means comprising two consumable electrodes in an elongate rod or wire form and a working gas flow to form an ionized arc between said two consumable electrodes, wherein said consumable electrodes provide said precursor catalyst material vaporizable therefrom by said ionized arc;
(b) operating said arc nozzle means to heat and at least partially vaporize said precursor catalyst material for providing a stream of nanometer-sized vapor clusters of said precursor catalyst material into a chamber in which said backing is disposed; and
(c) introducing a stream of a carrier gas into said chamber to impinge upon said stream of precursor vapor clusters to produce depositable nano clusters which are carried by said carrier gas to deposit onto a first side of said backing for forming said nano-structured catalyst coating.

26. The method of claim 25, wherein said carrier gas comprises a reactive gas that reacts with said precursor vapor clusters for producing said depositable nano clusters which are metal compounds or ceramic materials.

27. The method as set forth in claim 25, further comprising a sub-step of operating at least a second ionized arc nozzle means to completely vaporize said precursor catalyst material.

28. The method as set forth in claim 25, wherein said precursor material comprises at least one transition metal element selected from the group consisting of Groups IB, IIB, IIIB, IVB, VB, VIB, VIIB, and VIII elements of the Periodic Table of Elements, wherein said Group IB includes Cu, Ag, and Au; Group IIB includes Zn, Cd, and Hg; Group IIIB includes Sc, Y, and La, Group IVB includes Ti, Zr, and Hf; Group VB includes V, Nb, and Ta; Group VIB includes Co, Mo, W; Group VIIB includes Mn and Re; and Group VIII includes Fe, Co, Ni, Ru, Rh, Pd, Os, Ir, and Pt.

29. The method as set forth in claim 26, wherein said stream of reactive gas comprises a gas selected from the group consisting of hydrogen, oxygen, carbon, nitrogen, chlorine, fluorine, boron, sulfur, phosphorus, selenium, tellurium, arsenic vapor and combinations thereof.

30. A fuel cell comprising:
(A) an anode electrode;
(B) a cathode electrode;
(C) a fuel supply; and
(D) an electrolyte membrane comprising a solid electrolyte, wherein said membrane has a first side adjacent the anode electrode and a second side adjacent the cathode electrode, and wherein said electrolyte membrane further comprises a twin-wire arc-deposited catalyst on at least one of the first and second sides thereof, said twin-wire arc-deposited catalyst having a porosity effective for sustaining a voltage and gas flow across a membrane electrode assembly in said fuel cell.

31. The fuel cell of claim 30, wherein said twin-wire arc-deposited catalyst weight is from about 0.05 mg of catalyst per square centimeter of said electrolyte membrane to about 1.0 mg of catalyst per square centimeter of said electrolyte membrane.

32. The fuel cell of claim 30, wherein said catalyst is twin-wire arc-deposited to the first side, the second side or both sides of said electrolyte membrane.

33. The fuel cell of claim 30, wherein said catalyst comprises a transition metal.

34. The fuel cell of claim 30, wherein said catalyst is selected from the group consisting of Pt, Ru, Ni, Ti, Zr, Sn, SnO₂, Os, Ir, W, WO₃, and Re.

35. The fuel cell of claim 30, wherein said catalyst further comprises two or more catalysts.

36. The fuel cell of claim 30, wherein said fuel cell comprises a methanol fuel cell.

37. The fuel cell of claim 30, wherein said fuel cell comprises a hydrogen fuel cell.

38. The fuel cell of claim 30, wherein said fuel cell comprises a solid-oxide fuel cell.

39. A method for making a membrane electrode assembly, comprising:
(A) preparing a polymer electrolyte membrane, wherein the membrane has an eventual anode side and an eventual cathode side;
(B) twin-wire arc-depositing at least one catalyst onto at least one of the eventual anode side and the eventual cathode side of said electrolyte membrane; and
(C) bonding an anode to the eventual anode side of the membrane and a cathode to the eventual cathode side of the membrane.

40. The method of claim 39, wherein at least one of the anode and the cathode are made by:
obtaining a catalyst;
obtaining a backing; and
twin-wire arc-depositing said catalyst onto said backing.

41. The method of claim 39, wherein a first catalyst is twin-arc-deposited on the eventual anode side of the electrolyte membrane and a second catalyst is twin-arc-deposited on the eventual cathode side of the electrolyte membrane, and the first catalyst differs from the second catalyst.

42. The method of claim 5, wherein the step of preparing a membrane comprises feeding a segment of a membrane into said chamber from a feeding roll of said membrane positioned on one side of said chamber.

43. The method of claim 42, further comprising a post-deposition step of taking up said catalyst-deposited membrane using a winding roller positioned on another side of said chamber.

44. The method of claim 20, wherein the step of preparing a backing comprises feeding a segment of a backing layer into said chamber from a feeding roll of said backing layer positioned on one side of said chamber.

45. The method of claim 44, further comprising a post-deposition step of taking up said catalyst-deposited backing using a winding roller positioned on another side of said chamber.

46. The method of claim 39, wherein the step of preparing a polymer electrolyte membrane comprises feeding a segment of a polymer electrolyte membrane into said chamber from a feeding roll of said membrane positioned on one side of said chamber.

47. The method of claim 46, further comprising a post-deposition step of taking up said catalyst-deposited membrane using a winding roller positioned on another side of said chamber.

48. A fuel cell comprising:
(A) an anode electrode;
(B) a cathode electrode;
(C) a fuel supply; and
(D) an electrolyte membrane comprising a solid electrolyte, wherein said membrane has a
first side adjacent the anode electrode and a second side adjacent the cathode electrode;
wherein at least one of said anode electrode and cathode electrode comprises a twin-wire arc-deposited catalyst, said twin-wire arc-deposited catalyst having a porosity effective for sustaining a gas flow across said at least one electrode in said fuel cell.

49. An integrated method for making a fuel cell structure, comprising:
(A) feeding a polymer electrolyte membrane from a membrane source into a twin-wire arc deposition chamber continuously or intermittently on demand, wherein the membrane has an eventual anode side and an eventual cathode side;
(B) twin-wire arc-depositing at least one catalyst onto at least one of the eventual anode side and the eventual cathode side of said electrolyte membrane;
(C) feeding and bonding an anode to the eventual anode side of the membrane and a cathode to the eventual cathode side of the membrane to form a basic fuel cell structure; and
(D) collecting said basic fuel cell structure on a collector means.

50. The method of claim 49, wherein said membrane source and said collector means comprise a driving roller.

51. The method of claim 49, wherein step (B) comprises twin-wire arc-depositing one catalyst layer onto the eventual anode side and another catalyst layer to the eventual cathode side of said electrolyte membrane.
